(19) United States
(12) Patent Application Publication
(10) Pub. No.: US 2024/0124348 A1
(43) Pub. Date: Apr. 18, 2024

(54) ELECTRONIC GLASS HAVING HIGH LIQUIDUS VISCOSITY AND PREPARATION METHOD

(71) Applicant: CAIHONG DISPLAY DEVICES CO., LTD., Xianyang (CN)

(72) Inventors: Miao LI, Xianyang (CN); Zhao ZENG, Xianyang (CN); Guohong YANG, Xianyang (CN); Dacheng WANG, Xianyang (CN); Lihua XU, Xianyang (CN)

(73) Assignee: CAIHONG DISPLAY DEVICES CO., LTD., Xianyang (CN)

(21) Appl. No.: 18/399,534

(22) Filed: Dec. 28, 2023

Related U.S. Application Data
(63) Continuation of application No. PCT/CN2023/084854, filed on Mar. 29, 2023.

(30) Foreign Application Priority Data
Mar. 30, 2022 (CN) 2022103271565

(51) Int. Cl. C03C 3/091

(52) U.S. Cl. CPC C03C 3/091; C03B 17/064

(57) ABSTRACT

Disclosed are electronic glass having high liquidus viscosity and a preparation method. The proportions of the raw materials used in the electronic glass are: SiO₂: 65.56-68.6%; Al₂O₃: 10.58-14%; B₂O₃: 7-11%; SrO: 0.27-3.26%; BaO: 7.20-10.12%; CaO: 0.22-1.22%; MgO: 0-1.05%; MgO+CaO+SrO+BaO<13%; and the liquidus viscosity of the electronic glass is greater than 200,000 poise. The minimum value of the temperature corresponding to a liquidus temperature reduction of 100,000 poise in the electronic glass is 22° C. The electronic glass has a strain point temperature of 670-739° C., a Young's modulus of 70-83 GPa, and a density of 2.38-2.45 g/cm³, the liquidus viscosity is ensured to be higher than 200,000 poise, the electronic glass is well suited to overflow downdraw forming, and a relatively low density value can be obtained.

### CROSS-REFERENCE TO RELATED APPLICATIONS

The application claims priority to Chinese patent application No. 2022103271565, filed on Mar. 30, 2022, the entire contents of which are incorporated herein by reference.

### TECHNICAL FIELD

The present disclosure belongs to the field of photoelectric display, and particularly belongs to electronic glass having high liquidus viscosity and a preparation method.

### BACKGROUND

With the continuous development of display technology, people are increasingly pursuing high-resolution and high-quality pictures, and have higher requirements on the size and response time of thin film transistors (TFTs). Low-temperature polycrystalline silicon (LTPS) technology has become the mainstream TFT manufacturing technology at present because of high electron mobility (1,000 times higher than that of amorphous silicon technology), allowing driving integrated circuit (IC) and other electronic devices to be manufactured on glass substrates, reducing device costs, simplifying the later module process and improving the yield.

Laser annealing technology is widely used in the LTPS process to crystallize amorphous silicon layer. The most efficient poly-Si (p-Si) processing method is to operate at a temperature above 600° C., which can form a poly-Si film with extremely high electron mobility (for fast switching) and excellent TFT uniformity on a large area. This manufacturing method usually includes sequentially depositing thin films and forming patterns using methods of raising the temperature, and these methods cause the substrate to be heated to a temperature of 500° C. or above. At such high temperature, the glass substrate is easy to shrink to deform, which hinders the improvement of pixels. In order to prevent the glass substrate from shrinking and deforming in the subsequent thermal processing, the glass substrate needs to have a higher strain point temperature.

At the same time, there is an increasing market demand for large-sized displays, glass manufacturing is also moving toward higher generations, and the increase in weight of glass from one generation to the next generation significantly complicates automated conveyors for sequentially transporting glass to various processing points (factories or processes). Elastic sagging (deflection) of the Young's modulus will affect the ability to load, unload, and partition glass sheets in boxes that transport glass between processing points.

The amount of sagging (deflection) is a function of the geometry of the glass sheet, the density of the glass, and the Young's modulus, which can together be expressed as specific modulus. The geometry of the glass sheet is controlled by the specific process used, which is beyond the control of the glass manufacturer. For a fixed density, an increase in Young's modulus is advantageous because it reduces the amount of sag exhibited by large glass sheets during transportation, handling and thermal processing; similarly, any increase in density should be accompanied by a proportional increase in Young's modulus, otherwise increase in sag will be caused; therefore, in order to improve the yield of the glass sheets and reduce the amount of sagging (deflection) of the glass sheets, the Young's modulus of the glass substrate should be controlled above 70 GPa, and the density should be controlled below 2.45 g/cm3.

However, in the prior art, although the strain point and Young's modulus of glass are increased, the liquidus viscosity of the glass is small, and the difference between the corresponding temperature and the forming temperature corresponding to 100,000 poise becomes smaller, resulting in a small forming process margin, so that crystallization of glass occurs in the forming process, which leads to glass sheet breakage during production downdraw, thus affecting the production stability. Therefore, it is necessary to increase the liquidus viscosity of the glass to at least 200,000 poise, and the minimum value of the temperature corresponding to a liquidus temperature reduction of 100,000 poise in the glass is 22° C., i.e., ΔT≥22° C.

### SUMMARY

In order to solve the problems existing in the prior art, the present disclosure provides electronic glass having high liquidus viscosity and a preparation method for solving the above problems.

In order to achieve the above object, the present disclosure provides the following technical solutions:
there is provided electronic glass having high liquidus viscosity, wherein the proportions of the raw materials used in the electronic glass by mole percentage are: SiO2: 65.56-68.6%; Al2O3: 10.58-14%; B2O3: 7-11%; SrO: 0.27-3.26%; BaO: 7.20-10.12%; CaO: 0.22-1.22%; MgO: 0-1.05%;
MgO+CaO+SrO+BaO<13%;
the liquidus viscosity of the electronic glass is greater than 200,000 poise.

Preferably, the minimum value of the temperature corresponding to a liquidus temperature reduction of 100,000 poise in the electronic glass is 22° C.

Preferably, the electronic glass has a strain point temperature Ts ranging from 670° C. to 739° C.

Preferably, the electronic glass has a Young's modulus ranging from 70 GPa to 83 GPa.

Preferably, the electronic glass has a density ranging from 2.38 g/cm3 to 2.45 g/cm3.

A preparation method for electronic glass having high liquidus viscosity, including the following steps:
step 1, pouring raw materials into a mixer and mixing uniformly to form a mixture; wherein proportions of the raw materials used in the electronic glass by mole percentage are: SiO2: 65.56-68.6%; Al2O3: 10.58-14%; B2O3: 7-11%; SrO: 0.27-3.26%; BaO: 7.20-10.12%; CaO: 0.22-1.22%; MgO: 0-1.05%;
MgO+CaO+SrO+BaO<13%;
step 2, adding the mixture obtained in step 1 into a glass furnace, heating to melt the glass, and the melted glass entering a platinum feeding channel for clarification to be prepared into a glass melt; and
step 3, adopting a downdraw method to form the glass melt into electronic glass having high liquidus viscosity; wherein the liquidus viscosity of the electronic glass is greater than 200,000 poise.

Preferably, the minimum value of the temperature corresponding to a liquidus temperature reduction of 100,000 poise in the glass is 22° C.

Preferably, the electronic glass has a strain point temperature Ts ranging from 670° C. to 739° C.; the electronic glass has a Young's modulus ranging from 70 GPa to 83 GPa, and the electronic glass has a density ranging from 2.38 g/cm3 to 2.45 g/cm3.

Preferably, in step 2, a clarifying agent for clarification is SnO2, and the proportion of SnO2 in the raw materials is 0.05%.

Compared with the prior art, the present disclosure has the following beneficial technical effects:

According to the electronic glass having high liquidus viscosity provided by the present disclosure, a glass substrate having high liquidus viscosity can be obtained through composition optimization, thus meeting the requirement of stable production. In the present disclosure, according to the characteristic that SiO2 is mainly used to improve the viscosity, the overall mole percentage of SiO2 is controlled at 65.56%-68.6%, so that the forming temperature of the glass substrate will not be too high, and the service life of overflow bricks and glass defects will not be adversely affected, and the production difficulty is reduced, and the overall mole percentage of SiO2 cannot be lower than 65.56%, so that it can be ensured that the liquidus viscosity is higher than 200,000 poise, the glass is well suited to overflow downdraw forming, and a relatively low density value can be obtained.

Al2O3 can greatly improve the thermal stability of glass, reduce the tendency of glass crystallization, and at the same time improve the hardness and mechanical strength of glass, thus is suitable for producing flat glass with high dimensional accuracy. However, when the total content of Al2O3 is above 14%, the crystallization temperature of glass will increase and the crystallization viscosity will decrease, which is not conducive to overflow downdraw, so in order to give consideration to thermal stability, crystallization viscosity, mechanical strength and hardness of glass, the content of Al2O3 is 10.58%-14%.

B2O3 is a component that plays a role of flux, can reduce the viscosity, promote the melting of glass, and lower the temperature of glass production process. However, if the content of B2O3 is too high, the strain point temperature of glass will decrease rapidly, resulting in poor thermal stability. Therefore, in the embodiments, the content of B2O3 is maintained between 7% and 11%. If the content of B2O3 is less than 7%, its effect as a flux is insufficient, and simply reducing the content of B2O3 will cause other problems, including the deterioration of melting ability and the increase of bubbles. On the other hand, higher B2O3 content tends to reduce the acid resistance, and at the same time, the strain point of glass decreases, thus the thermal stability decreases.

Alkaline-earth metal oxides can reduce the overall viscosity of liquid glass, which is beneficial to the reduction of the production process temperature. However, if the content is too high, the density will increase, the strain point temperature will decrease, the chemical durability will deteriorate, and the thermal expansion coefficient will increase, so the total content of alkaline-earth metal oxides cannot be higher than 13%. Mixed oxides of alkaline earth metals can decrease the liquidus temperature and increase the liquidus viscosity, thus facilitating overflow drawdown production.

Further, by limiting the minimum value of the temperature corresponding to a liquidus temperature reduction of 100,000 poise in the glass to 22° C., crystallization can be avoided in the glass forming process, and the glass can be prevented from breaking after crystallization, thus ensuring the production progress.

### DETAILED DESCRIPTION OF THE EMBODIMENTS

The present disclosure will be further described in detail below with reference to specific examples, which are intended to explain, but not to limit, the present disclosure.

The proportions of raw materials, according to data in the tables of the following examples, used in electronic glass having high liquidus viscosity provided by the present disclosure by mole percentage are: SiO2: 65.56-68.6%; Al2O3: 10.58-14%; B2O3: 7-11%; SrO: 0.27-3.26%; BaO: 7.20-10.12%; CaO: 0.22-1.22%; MgO: 0-1.05%;
MgO+CaO+SrO+BaO<13%; the liquidus viscosity of this electronic glass is greater than 200,000 poise.

The electronic glass of the present disclosure has a strain point temperature Ts ranging from 670° C. to 739° C., a Young's modulus ranging from 70 GPa to 83 GPa, and a density ranging from 2.38 g/cm3 to 2.45 g/cm3.

According to the electronic glass having high liquidus viscosity provided by the present disclosure, a glass substrate having high liquidus viscosity can be obtained through composition optimization, thus meeting the requirement of stable production. In the present disclosure, according to the characteristic that SiO2 is mainly used to improve the viscosity, the overall mole percentage of SiO2 is controlled at 65.56%-68.6%, so that the forming temperature of the glass substrate will not be too high, and the service life of overflow bricks and glass defects will not be adversely affected, and the production difficulty is reduced, and the overall mole percentage of SiO2 cannot be lower than 65.56%, so that it can be ensured that the liquidus viscosity is higher than 200,000 poise, the glass is well suited to overflow downdraw forming, and a relatively low density value can be obtained.

Al2O3 can greatly improve the thermal stability of glass, reduce the tendency of glass crystallization, and at the same time improve the hardness and mechanical strength of glass, thus is suitable for producing flat glass with high dimensional accuracy. However, when the total content of Al2O3 is above 14%, the crystallization temperature of glass will increase and the crystallization viscosity will decrease, which is not conducive to overflow downdraw, so in order to give consideration to thermal stability, crystallization viscosity, mechanical strength and hardness of glass, the content of Al2O3 is 10.58%-14%.

B2O3 is a component that plays a role of flux, can reduce the viscosity, promote the melting of glass, and lower the temperature of glass production process. However, if the content of B2O3 is too high, the strain point temperature of glass will decrease rapidly, resulting in poor thermal stability. Therefore, in the embodiments, the content of B2O3 is maintained between 7% and 11%. If the content of B2O3 is less than 7%, its effect as a flux is insufficient, and simply reducing the content of B2O3 will cause other problems, including the deterioration of melting ability and the increase of bubbles. On the other hand, higher B2O3 content tends to reduce the acid resistance, and at the same time, the strain point of glass decreases, thus the thermal stability decreases.

Alkaline-earth metal oxides can reduce the overall viscosity of liquid glass, which is beneficial to the reduction of the production process temperature. However, if the content is too high, the density will increase, the strain point temperature will decrease, the chemical durability will deteriorate, and the thermal expansion coefficient will increase, so the total content of alkaline-earth metal oxides cannot be higher than 13%. Mixed oxides of alkaline earth metals can decrease the liquidus temperature and increase the liquidus viscosity, thus facilitating overflow drawdown production.

The minimum value of the temperature corresponding to a liquidus temperature reduction of 100,000 poise in the electronic glass is 22° C. By limiting the minimum value of the temperature corresponding to a liquidus temperature reduction of 100,000 poise in the glass to 22° C., crystallization can be avoided in the glass forming process, and the glass can be prevented from breaking after crystallization, thus ensuring the production progress.

The present disclosure provides a preparation method for electronic glass having high liquidus viscosity, including the following steps:
step 1, pouring raw materials into a mixer and mixing uniformly to form a mixture; wherein proportions of the raw materials are: SiO2: 65.56-68.6%; Al2O3: 10.58-14%; B2O3: 7-11%; SrO: 0.27-3.26%; BaO: 7.20-10.12%; CaO: 0.22-1.22%; MgO: 0-1.05%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt; and
step 3, adopting a downdraw method to form the glass melt into electronic glass having high liquidus viscosity; wherein the liquidus viscosity of the electronic glass is greater than 200,000 poise.

### Example 1

A preparation method for electronic glass having high liquidus viscosity, including the following steps:
step 1, pouring raw materials into a mixer and mixing uniformly to form a mixture; wherein proportions of the raw materials by mole percentage are: SiO2: 66.00%; Al2O3: 13.00%; B2O3: 10.01%; SrO: 1.27%; BaO: 8.86%; CaO: 0.73%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 267719.7 poise.

The electronic glass in Example 1 has a strain point temperature Ts of 723° C., a Young's modulus of 82 GPa and a density of 2.39 g/cm3, and the temperature corresponding to a liquidus temperature reduction of 100,000 poise in the electronic glass is 25° C.

### Example 2

A preparation method for electronic glass having high liquidus viscosity, including the following steps:
step 1, pouring raw materials into a mixer and mixing uniformly to form a mixture; wherein proportions of the raw materials by mole percentage are: SiO2: 68.60%; Al2O3: 14%; B2O3: 7.32%; SrO: 0.27%; BaO: 8.95%; CaO: 0.74%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 218351.3 poise.

The electronic glass in Example 2 has a strain point temperature Ts of 739° C., a Young's modulus of 83 GPa and a density of 2.38 g/cm3, and the temperature corresponding to a liquidus temperature reduction of 100,000 poise in the electronic glass is 30° C.

### Example 3

A preparation method for electronic glass having high liquidus viscosity, including the following steps:
step 1, pouring raw materials into a mixer and mixing uniformly to form a mixture; wherein proportions of the raw materials by mole percentage are: SiO2: 67.00%; Al2O3: 10.87%; B2O3: 9.82%; SrO: 3.23%; BaO: 8.24%: CaO: 0.71%; MgO: 0.08%;

MgO+CaO+SrO+BaO<13%:
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 206347.1 poise.

The electronic glass in Example 3 has a strain point temperature Ts of 687° C., a Young's modulus of 75 GPa and a density of 2.42 g/cm3, and the temperature corresponding to a liquidus temperature reduction of 100,000 poise in the electronic glass is 28° C.

### Example 4

A preparation method for electronic glass having high liquidus viscosity, including the following steps:
step 1, pouring raw materials into a mixer and mixing uniformly to form a mixture; wherein proportions of the raw materials by mole percentage are: SiO2: 66.56%; Al2O3: 10.87%; B2O3: 9.82%; SrO: 2.24%; BaO: 9.67%; CaO: 0.71%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 317280.6 poise.

The electronic glass in Example 4 has a strain point temperature Ts of 680° C., a Young's modulus of 76 GPa and a density of 2.45 g/cm3, and the temperature corresponding to a liquidus temperature reduction of 100,000 poise in the electronic glass is 38° C.

### Example 5

A preparation method for electronic glass having high liquidus viscosity, including the following steps:
step 1, pouring raw materials into a mixer and mixing uniformly to form a mixture; wherein proportions of the raw materials by mole percentage are: SiO2: 66.23%; Al2O3: 10.82%; B2O3: 11.00%; SrO: 1.22%; BaO: 10.12%; CaO: 0.49%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 290999.8 poise.

The electronic glass in Example 5 has a strain point temperature Ts of 673° C., a Young's modulus of 70 GPa and a density of 2.43 g/cm3, and the temperature corresponding to a liquidus temperature reduction of 100,000 poise in the electronic glass is 26° C.

### Example 6

A preparation method for electronic glass having high liquidus viscosity, including the following steps:
step 1, pouring raw materials into a mixer and mixing uniformly to form a mixture; wherein proportions of the raw materials by mole percentage are: SiO2: 67.91%; Al2O3: 13.20%; B2O3: 7.00%; SrO: 2.31%; BaO: 7.85%: CaO: 0.73%; MgO: 0.95%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 412501.0 poise.

The electronic glass in Example 6 has a strain point temperature Ts of 723° C., a Young's modulus of 82 GPa and a density of 2.43 g/cm3, and the temperature corresponding to a liquidus temperature reduction of 100,000 poise in the electronic glass is 46° C.

### Example 7

A preparation method for electronic glass having high liquidus viscosity, including the following steps:
step 1, pouring raw materials into a mixer and mixing uniformly to form a mixture; wherein proportions of the raw materials by mole percentage are: SiO2: 68.08%; Al2O3: 11.04%; B2O3: 9.24%; SrO: 2.22%; BaO: 8.83%: CaO: 0.49%: MgO: 0.02%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 223978.5 poise.

The electronic glass in Example 7 has a strain point temperature Ts of 704° C., a Young's modulus of 81 GPa and a density of 2.44 g/cm3, and the temperature corresponding to a liquidus temperature reduction of 100,000 poise in the electronic glass is 31° C.

### Example 8

A preparation method for electronic glass having high liquidus viscosity, including the following steps:
step 1, pouring raw materials into a mixer and mixing uniformly to form a mixture; wherein proportions of the raw materials by mole percentage are: SiO2: 67.56%; Al2O3: 11.04%; B2O3: 9.96%; SrO: 2.27%; BaO: 8.82%: CaO: 0.22%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 260487.4 poise.

The electronic glass in Example 8 has a strain point temperature Ts of 694° C. a Young's modulus of 81 GPa and a density of 2.38 g/cm3, and the temperature corresponding to a liquidus temperature reduction of 100,000 poise in the electronic glass is 36° C.

### Example 9

A preparation method for electronic glass having high liquidus viscosity, including the following steps:
step 1, pouring raw materials into a mixer and mixing uniformly to form a mixture; wherein proportions of the raw materials by mole percentage are: SiO2: 66.89%; Al2O3: 10.93%; B2O3: 9.86%; SrO: 2.25%; BaO: 8.73%; CaO: 1.22%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 395876.8 poise.

The electronic glass in Example 9 has a strain point temperature Ts of 679° C., a Young's modulus of 74 GPa and a density of 2.42 g/cm3, and the temperature corresponding to a liquidus temperature reduction of 100,000 poise in the electronic glass is 52° C.

### Example 10

A preparation method for electronic glass having high liquidus viscosity, including the following steps:
step 1, pouring raw materials into a mixer and mixing uniformly to form a mixture; wherein proportions of the raw materials by mole percentage are: SiO2: 67.28%; Al2O3: 10.99%; B2O3: 9.92%; SrO: 2.21%; BaO: 7.78%; CaO: 0.72%; MgO: 1.05%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 363697.3 poise.

The electronic glass in Example 10 has a strain point temperature Ts of 688° C., a Young's modulus of 76 GPa and a density of 2.43 g/cm3, and the temperature corresponding to a liquidus temperature reduction of 100,000 poise in the electronic glass is 42° C.

### Example 11

A preparation method for electronic glass having high liquidus viscosity, including the following steps:
step 1, pouring raw materials into a mixer and mixing uniformly to form a mixture; wherein proportions of the raw materials by mole percentage are: SiO2: 67.09%; Al2O3: 10.96%; B2O3: 9.89%; SrO: 2.26%; BaO: 8.75%; CaO: 0.72%; MgO: 0.27%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 359805.6 poise.

The electronic glass in Example 11 has a strain point temperature Ts of 691° C., a Young's modulus of 75 GPa and a density of 2.4 g/cm3, and the temperature corresponding to a liquidus temperature reduction of 100,000 poise in the electronic glass is 44° C.

### Example 12

A preparation method for electronic glass having high liquidus viscosity, including the following steps:
step 1, pouring raw materials into a mixer and mixing uniformly to form a mixture; wherein proportions of the raw materials by mole percentage are: SiO2: 67.23%; Al2O3: 12.98%; B2O3: 8.42%; SrO: 2.26%; BaO: 8.27%; CaO: 0.72%; MgO: 0.07%;

MgO+CaO+SiO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 258442.4 poise.

The electronic glass in Example 12 has a strain point temperature Ts of 715° C., a Young's modulus of 75 GPa and a density of 2.41 g/cm3, and the temperature corresponding to a liquidus temperature reduction of 100,000 poise in the electronic glass is 34° C.

### Example 13

A preparation method for electronic glass having high liquidus viscosity, including the following steps:
step 1, pouring raw materials into a mixer and mixing uniformly to form a mixture; wherein proportions of the raw materials by mole percentage are: SiO2: 67.23%; Al2O3: 11.98%; B2O3: 8.41%; SrO: 2.26%; BaO: 9.27%; CaO: 0.72%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 276728.3 poise.

The electronic glass in Example 13 has a strain point temperature Ts of 715° C., a Young's modulus of 79 GPa and a density of 2.4 g/cm3, and the temperature corresponding to a liquidus temperature reduction of 100,000 poise in the electronic glass is 37° C.

### Example 14

A preparation method for electronic glass having high liquidus viscosity, including the following steps:
step 1, pouring raw materials into a mixer and mixing uniformly to form a mixture; wherein proportions of the raw materials by mole percentage are: SiO2: 67.08%; Al2O3: 10.99%; B2O3: 10.12%; SrO: 2.26%; BaO: 8.78%; CaO: 0.72%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 229892.2 poise.

The electronic glass in Example 14 has a strain point temperature Ts of 690° C., a Young's modulus of 72 GPa and a density of 2.39 g/cm3, and the temperature corresponding to a liquidus temperature reduction of 100,000 poise in the electronic glass is 31° C.

### Example 15

A preparation method for electronic glass having high liquidus viscosity, including the following steps:
step 1, pouring raw materials into a mixer and mixing uniformly to form a mixture; wherein proportions of the raw materials by mole percentage are: SiO2: 66.89%; Al2O3: 10.93%; B2O3: 9.86%; SrO: 2.25%; BaO: 8.73%; CaO: 0.72%; MgO: 0.57%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 200550.0 poise.

The electronic glass in Example 15 has a strain point temperature Ts of 686° C., a Young's modulus of 76 GPa and a density of 2.4 g/cm3, and the temperature corresponding to a liquidus temperature reduction of 100,000 poise in the electronic glass is 23° C.

### Example 16

A preparation method for electronic glass having high liquidus viscosity, including the following steps:
step 1, pouring raw materials into a mixer and mixing uniformly to form a mixture; wherein proportions of the raw materials by mole percentage are: SiO2: 65.56%; Al2O3: 13.87%; B2O3: 7.82%; SrO: 2.24%; BaO: 8.68%; CaO: 1.70%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 229342.6 poise.

The electronic glass in Example 16 has a strain point temperature Ts of 722° C., a Young's modulus of 83 GPa and a density of 2.42 g/cm3, and the temperature corresponding to a liquidus temperature reduction of 100,000 poise in the electronic glass is 28° C.

### Example 17

A preparation method for electronic glass having high liquidus viscosity, including the following steps:
step 1, pouring raw materials into a mixer and mixing uniformly to form a mixture; wherein proportions of the raw materials by mole percentage are: SiO2: 66.55%; Al2O3: 11.87%; B2O3: 9.82%; SrO: 2.24%; BaO: 8.68%; CaO: 0.71%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 229342.6 poise.

The electronic glass in Example 17 has a strain point temperature Ts of 696° C., a Young's modulus of 78 GPa and a density of 2.41 g/cm3, and the temperature corresponding to a liquidus temperature reduction of 100,000 poise in the electronic glass is 37° C.

### Example 18

A preparation method for electronic glass having high liquidus viscosity, including the following steps:
step 1, pouring raw materials into a mixer and mixing uniformly to form a mixture; wherein proportions of the raw materials by mole percentage are: SiO2: 67.73%; Al2O3: 10.98%; B2O3: 9.41%; SrO: 2.26%; BaO: 8.77%; CaO: 0.72%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 269925.4 poise.

The electronic glass in Example 18 has a strain point temperature Ts of 695° C., a Young's modulus of 74 GPa and a density of 2.41 g/cm3, and the temperature corresponding to a liquidus temperature reduction of 100,000 poise in the electronic glass is 39° C.

### Example 19

A preparation method for electronic glass having high liquidus viscosity, including the following steps:
step 1, pouring raw materials into a mixer and mixing uniformly to form a mixture; wherein proportions of the raw materials by mole percentage are: SiO2: 68.30%; Al2O3: 10.88%; B2O3: 10.50%; SrO: 2.20%; BaO: 7.20%; CaO: 0.80%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 348081.8 poise.

The electronic glass in Example 19 has a strain point temperature Ts of 683° C., a Young's modulus of 72 GPa and a density of 2.4 g/cm3, and the temperature corresponding to a liquidus temperature reduction of 100,000 poise in the electronic glass is 49° C.

### Example 20

A preparation method for electronic glass having high liquidus viscosity, including the following steps:
step 1, pouring raw materials into a mixer and mixing uniformly to form a mixture; wherein proportions of the raw materials by mole percentage are: SiO2: 67.53%; Al2O3: 11.68%; B2O3: 8.98%; SrO: 2.76%; BaO: 8.28%; CaO: 0.72%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 210081.0 poise.

The electronic glass in Example 20 has a strain point temperature Ts of 689° C., a Young's modulus of 74 GPa and a density of 2.4 g/cm3, and the temperature corresponding to a liquidus temperature reduction of 100,000 poise in the electronic glass is 22° C.

### Example 21

A preparation method for electronic glass having high liquidus viscosity, including the following steps:
step 1, pouring raw materials into a mixer and mixing uniformly to form a mixture; wherein proportions of the raw materials by mole percentage are: SiO2: 67.64%; Al2O3: 10.58%; B2O3: 9.98%; SrO: 3.26%; BaO: 7.77%; CaO: 0.72%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 415818.6 poise.

The electronic glass in Example 21 has a strain point temperature Ts of 686° C., a Young's modulus of 71 GPa and a density of 2.39 g/cm3, and the temperature corresponding to a liquidus temperature reduction of 100,000 poise in the electronic glass is 46° C.

### Example 22

A preparation method for electronic glass having high liquidus viscosity, including the following steps:
step 1, pouring raw materials into a mixer and mixing uniformly to form a mixture; wherein proportions of the raw materials by mole percentage are: SiO2: 67.93%; Al2O3: 12.78%; B2O3: 7.42%; SrO: 2.26%; BaO: 8.77%; CaO: 0.72%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 273255.6 poise.

The electronic glass in Example 22 has a strain point temperature Ts of 729° C., a Young's modulus of 81 GPa and a density of 2.39 g/cm3, and the temperature corresponding to a liquidus temperature reduction of 100,000 poise in the electronic glass is 36° C.

### Example 23

A preparation method for electronic glass having high liquidus viscosity, including the following steps:
step 1, pouring raw materials into a mixer and mixing uniformly to form a mixture; wherein proportions of the raw materials by mole percentage are: SiO2: 66.73%; Al2O3: 11.00%; B2O3: 10.40%; SrO: 2.26%; BaO: 8.77%; CaO: 0.72%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 408819.2 poise.

The electronic glass in Example 23 has a strain point temperature Ts of 687° C., a Young's modulus of 72 GPa and a density of 2.4 g/cm3, and the temperature corresponding to a liquidus temperature reduction of 100,000 poise in the electronic glass is 55° C.

### Example 24

A preparation method for electronic glass having high liquidus viscosity, including the following steps:
step 1, pouring raw materials into a mixer and mixing uniformly to form a mixture; wherein proportions of the raw materials by mole percentage are: SiO2: 67.23%; Al2O3: 10.98%; B2O3: 10.42%; SrO: 2.16%; BaO: 8.40%; CaO: 0.69%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 338660.9 poise.

The electronic glass in Example 24 has a strain point temperature Ts of 670° C., a Young's modulus of 70 GPa and a density of 2.39 g/cm3, and the temperature corresponding to a liquidus temperature reduction of 100,000 poise in the electronic glass is 40° C.

### Example 25

A preparation method for electronic glass having high liquidus viscosity, including the following steps:
step 1, pouring raw materials into a mixer and mixing uniformly to form a mixture; wherein proportions of the raw materials by mole percentage are: SiO2: 67.57%; Al2O3: 11.04%; B2O3: 9.96%; SrO: 2.17%; BaO: 8.44%; CaO: 0.69%; MgO: 0.07%:

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 491490.0 poise.

The electronic glass in Example 25 has a strain point temperature Ts of 693° C., a Young's modulus of 76 GPa and a density of 2.4 g/cm3, and the temperature corresponding to a liquidus temperature reduction of 100,000 poise in the electronic glass is 49° C.

### Example 26

A preparation method for electronic glass having high liquidus viscosity, including the following steps:
step 1, pouring raw materials into a mixer and mixing uniformly to form a mixture; wherein proportions of the raw materials by mole percentage are: SiO2: 66.73%; Al2O3: 12.56%; B2O3: 7.91%; SrO: 2.59%; BaO: 8.40%; CaO: 0.69%; MgO: 0.07%;

MgO+CaO+SrO+BaO<13%;
step 2, adding the mixture obtained in step 1 into a glass furnace, heating to melt the glass, and the melted glass entering a platinum feeding channel for clarification to be prepared into a glass melt, wherein 0.05% SnO2 is added during clarification; and
step 3, adopting a downdraw method to form the glass melt into electronic glass having high liquidus viscosity; wherein the liquidus viscosity of the electronic glass is 263689.7 poise.

The electronic glass in Example 26 has a strain point temperature Ts of 717° C., a Young's modulus of 82 GPa and a density of 2.42 g/cm3, and the temperature corresponding to a liquidus temperature reduction of 100,000 poise in the electronic glass is 24° C.

Table of composition proportion data of the above examples

| Oxide | 1 | 2 | 3 | 4 | 5 |
|---|---|---|---|---|---|
| SiO₂ | 66.00% | 68.60% | 67.00% | 66.56% | 66.23% |
| Al₂O₃ | 13.00% | 14.00% | 10.87% | 10.87% | 10.82% |
| B₂O₃ | 10.01% | 7.32% | 9.82% | 9.82% | 11.00% |
| SrO | 1.27% | 0.27% | 3.23% | 2.24% | 1.22% |
| BaO | 8.86% | 8.95% | 8.24% | 9.67% | 10.12% |
| CaO | 0.73% | 0.74% | 0.71% | 0.71% | 0.49% |
| MgO | 0.07% | 0.07% | 0.08% | 0.07% | 0.07% |
| SnO₂ | 0.05% | 0.05% | 0.05% | 0.05% | 0.05% |
| sum | 100.00% | 100.00% | 100.00% | 100.00% | 100.00% |
| RO | 11% | 10% | 12% | 13% | 12% |
| Young's | 82 | 83 | 75 | 76 | 70 |
| modulus GPa | | | | | |
| Softening | 1028 | 1044 | 977 | 975 | 959 |
| point ° C. | | | | | |
| Annealing | 781 | 797 | 742 | 736 | 727 |
| point ° C. | | | | | |
| Strain point ° C. | 723 | 739 | 687 | 680 | 673 |
| T_{100000Poise} ° C. | 1178 | 1190 | 1154 | 1153 | 1143 |
| Liquidus | 1153.7 | 1160 | 1126.2 | 1114.9 | 1117.1 |
| temperature ° C. | | | | | |
| Liquidus | 267719.7 | 218351.3 | 206347.1 | 317280.6 | 290999.8 |
| viscosity | | | | | |
| dPa · s | | | | | |
| Density g/cm³ | 2.39 | 2.38 | 2.42 | 2.45 | 2.43 |
| ΔT ° C. | 25 | 30 | 28 | 38 | 26 |
| Oxide | 6 | 7 | 8 | 9 | 10 |
| SiO₂ | 67.91% | 68.08% | 67.56% | 66.89% | 67.28% |
| Al₂O₃ | 13.20% | 11.04% | 11.04% | 10.93% | 10.99% |
| B₂O₃ | 7.00% | 9.24% | 9.96% | 9.86% | 9.92% |
| SrO | 2.31% | 2.22% | 2.27% | 2.25% | 2.21% |
| BaO | 7.85% | 8.83% | 8.82% | 8.73% | 7.78% |
| CaO | 0.73% | 0.49% | 0.22% | 1.22% | 0.72% |
| MgO | 0.95% | 0.02% | 0.07% | 0.07% | 1.05% |
| SnO₂ | 0.05% | 0.08% | 0.05% | 0.05% | 0.05% |
| sum | 100.00% | 100.00% | 100.00% | 100.00% | 100.00% |
| RO | 12% | 12% | 11% | 12% | 12% |
| Young's | 82 | 81 | 81 | 74 | 76 |
| modulus GPa | | | | | |
| Softening | 1021 | 1006 | 1004 | 994 | 994 |
| point ° C. | | | | | |
| Annealing | 779 | 759 | 754 | 738 | 748 |
| point ° C. | | | | | |
| Strain point ° C. | 723 | 704 | 694 | 679 | 688 |
| T_{100000Poise} ° C. | 1173 | 1186 | 1193 | 1179 | 1170 |
| Liquidus | 1127.5 | 1154.3 | 1157.2 | 1126.5 | 1127.2 |
| temperature ° C. | | | | | |
| Liquidus | 412501.0 | 223978.5 | 260487.4 | 395876.8 | 363697.3 |
| viscosity | | | | | |
| dPa · s | | | | | |
| Density g/cm³ | 2.43 | 2.44 | 2.38 | 2.42 | 2.43 |
| ΔT ° C. | 46 | 31 | 36 | 52 | 42 |
| Oxide | 11 | 12 | 13 | 14 | 15 |
| SiO₂ | 67.09% | 67.23% | 67.23% | 67.08% | 66.89% |
| Al₂O₃ | 10.96% | 12.98% | 11.98% | 10.99% | 10.93% |
| B₂O₃ | 9.89% | 8.42% | 8.41% | 10.12% | 9.86% |
| SrO | 2.26% | 2.26% | 2.26% | 2.26% | 2.25% |
| BaO | 8.75% | 8.27% | 9.27% | 8.78% | 8.73% |
| CaO | 0.72% | 0.72% | 0.72% | 0.72% | 0.72% |
| MgO | 0.27% | 0.07% | 0.07% | 0.00% | 0.57% |
| SnO₂ | 0.05% | 0.05% | 0.05% | 0.05% | 0.05% |
| sum | 100.00% | 100.00% | 100.00% | 100.00% | 100.00% |
| RO | 12% | 11% | 12% | 12% | 12% |
| Young's | 75 | 80 | 79 | 72 | 76 |
| modulus GPa | | | | | |
| Softening | 988 | 1020 | 1014 | 999 | 992 |
| point ° C. | | | | | |
| Annealing | 744 | 776 | 770 | 749 | 745 |
| point ° C. | | | | | |
| Strain point ° C. | 691 | 715 | 714 | 690 | 686 |
| T_{100000Poise} ° C. | 1175 | 1171 | 1178 | 1175 | 1168 |
| Liquidus | 1131.5 | 1137 | 1141 | 1143.8 | 1145.5 |
| temperature ° C. | | | | | |
| Liquidus | 359805.6 | 258442.4 | 276728.3 | 229892.2 | 200550.0 |
| viscosity | | | | | |
| dPa · s | | | | | |
| Density g/cm³ | 2.4 | 2.41 | 2.4 | 2.39 | 2.4 |
| ΔT ° C. | 44 | 34 | 37 | 31 | 23 |
| Oxide | 16 | 17 | 18 | 19 | 20 |
| SiO₂ | 65.56% | 66.55% | 67.73% | 68.30% | 67.53% |
| Al₂O₃ | 13.87% | 11.87% | 10.98% | 10.88% | 11.68% |
| B₂O₃ | 7.82% | 9.82% | 9.41% | 10.50% | 8.98% |
| SrO | 2.24% | 2.24% | 2.26% | 2.20% | 2.76% |
| BaO | 8.68% | 8.68% | 8.77% | 7.20% | 8.28% |
| CaO | 1.70% | 0.71% | 0.72% | 0.80% | 0.72% |
| MgO | 0.07% | 0.07% | 0.07% | 0.07% | 0 |
| SnO₂ | 0.05% | 0.05% | 0.05% | 0.05% | 0.05% |
| sum | 100.00% | 100.00% | 100.00% | 100.00% | 100.00% |
| RO | 13% | 12% | 12% | 10% | 12% |
| Young's | 83 | 78 | 74 | 72 | 74 |
| modulus GPa | | | | | |
| Softening | 1023 | 1005 | 1001 | 1000 | 998 |
| point ° C. | | | | | |
| Annealing | 777 | 758 | 755 | 743 | 751 |
| point ° C. | | | | | |
| Strain point ° C. | 722 | 696 | 695 | 683 | 689 |
| T_{100000Poise} ° C. | 1163 | 1163 | 1173 | 1176 | 1174 |
| Liquidus | 1135.8 | 1126.6 | 1134.4 | 1127.4 | 1151.3 |
| temperature ° C. | | | | | |
| Liquidus | 229342.6 | 242399.5 | 269925.4 | 348081.8 | 210081.0 |
| viscosity | | | | | |
| dPa · s | | | | | |
| Density g/cm³ | 2.42 | 2.41 | 2.41 | 2.4 | 2.4 |
| ΔT ° C. | 28 | 37 | 39 | 49 | 22 |
| Oxide | 21 | 22 | 23 | 24 | 25 |
| SiO₂ | 67.64% | 67.93% | 66.73% | 67.23% | 67.57% |
| Al₂O₃ | 10.58% | 12.78% | 11.00% | 10.98% | 11.04% |
| B₂O₃ | 9.98% | 7.42% | 10.40% | 10.42% | 9.96% |
| SrO | 3.26% | 2.26% | 2.26% | 2.16% | 2.17% |
| BaO | 7.77% | 8.77% | 8.77% | 8.40% | 8.44% |
| CaO | 0.72% | 0.72% | 0.72% | 0.69% | 0.69% |
| MgO | 0 | 0.07% | 0.07% | 0.07% | 0.07% |
| SnO₂ | 0.05% | 0.05% | 0.05% | 0.05% | 0.05% |
| sum | 100.00% | 100.00% | 100.00% | 100.00% | 100.00% |
| RO | 12% | 12% | 12% | 11% | 11% |
| Young's | 71 | 81 | 72 | 70 | 76 |
| modulus GPa | | | | | |
| Softening | 999 | 1034 | 998 | 983 | 1005 |
| point ° C. | | | | | |
| Annealing | 748 | 786 | 748 | 730 | 756 |
| point ° C. | | | | | |
| Strain point ° C. | 686 | 729 | 687 | 670 | 693 |
| T_{100000Poise} ° C. | 1174 | 1175 | 1179 | 1169 | 1179 |
| Liquidus | 1127.7 | 1138.2 | 1124.4 | 1128.9 | 1129.3 |
| temperature ° C. | | | | | |
| Liquidus | 415818.6 | 273255.6 | 408819.2 | 338660.9 | 491490.0 |
| viscosity | | | | | |
| dPa · s | | | | | |
| Density g/cm³ | 2.39 | 2.39 | 2.4 | 2.39 | 2.4 |
| ΔT ° C. | 46 | 36. | 55 | 40 | 49 |

| Oxide | 26 |
|---|---|
| SiO₂ | 67.73% |
| Al₂O₃ | 12.56% |
| B₂O₃ | 7.91% |
| SrO | 2.59% |
| BaO | 8.40% |
| CaO | 0.69% |
| MgO | 0.07% |
| SnO₂ | 0.05% |
| sum | 100.00% |
| RO | 12% |
| Young's | 82 |
| modulus GPa | |
| Softening | 1026 |
| point ° C. | |
| Annealing | 775 |
| point ° C. | |
| Strain point ° C. | 717 |
| T_{100000Poise} ° C. | 1176 |
| Liquidus | 1152.1 |
| temperature ° C. | |
| Liquidus | 263689.7 |
| viscosity | |
| dPa · s | |
| Density g/cm³ | 2.42 |
| ΔT ° C. | 24 |

What is claimed is:

1. Electronic glass having high liquidus viscosity, wherein proportions of raw materials used in the electronic glass by mole percentage are: SiO₂: 65.56-68.6%; Al2O₃: 10.58-14%; B₂O₃: 7-11%; SrO: 0.27-3.26%; BaO: 7.20-10.12%; CaO: 0.22-1.22%; MgO: 0-1.05%;
MgO+CaO+SrO+BaO<13%;
the liquidus viscosity of the electronic glass is greater than 200,000 poise.

2. The electronic glass having high liquidus viscosity according to claim 1, wherein a minimum value of a temperature corresponding to a liquidus temperature reduction of 100,000 poise in the electronic glass is 22° C.

3. The electronic glass having high liquidus viscosity according to claim 1, wherein the electronic glass has a strain point temperature Ts ranging from 670° C. to 739° C.

4. The electronic glass having high liquidus viscosity according to claim 1, wherein the electronic glass has a Young's modulus ranging from 70 GPa to 83 GPa.

5. The electronic glass having high liquidus viscosity according to claim 1, wherein the electronic glass has a density ranging from 2.38 g/cm³ to 2.45 g/cm³.

6. A preparation method for electronic glass having high liquidus viscosity, comprising the following steps:
step 1, pouring raw materials into a mixer and mixing uniformly to form a mixture; wherein proportions of the raw materials used in the electronic glass by mole percentage are: SiO₂: 65.56-68.6%; Al₂O₃: 10.58-14%; B₂O₃: 7-11%; SrO: 0.27-3.26%; BaO: 7.20-10.12%; CaO: 0.22-1.22%; MgO: 0-1.05%;
MgO+CaO+SrO+BaO<13%;
step 2, adding the mixture obtained in step 1 into a glass furnace, heating to melt the glass, and the melted glass entering a platinum feeding channel for clarification to be prepared into a glass melt; and
step 3, adopting a downdraw method to form the glass melt into electronic glass having high liquidus viscosity; wherein the liquidus viscosity of the electronic glass is greater than 200,000 poise.

7. The preparation method for electronic glass having high liquidus viscosity according to claim 6, wherein a minimum value of a temperature corresponding to a liquidus temperature reduction of 100,000 poise in the glass is 22° C.

8. The preparation method for electronic glass having high liquidus viscosity according to claim 6, wherein the electronic glass has a strain point temperature Ts ranging from 670° C. to 739° C.; the electronic glass has a Young's modulus ranging from 70 GPa to 83 GPa, and the electronic glass has a density ranging from 2.38 g/cm³ to 2.45 g/cm³.

9. The preparation method for electronic glass having high liquidus viscosity according to claim 6, wherein in step 2, a clarifying agent for clarification is SnO₂, and the proportion of SnO₂ in the raw materials is 0.05%.
